(19) United States
(12) Patent Application Publication
(10) Pub. No.: US 2017/0124623 A1
(43) Pub. Date: May 4, 2017

(54) PERSONALIZED PRODUCT LABELING

(71) Applicant: INTERNATIONAL BUSINESS MACHINES CORPORATION, ARMONK, NY (US)

(72) Inventors: KEKE CAI, BEIJING (CN); HONGLEI GUO, BEIJING (CN); JIAN MIN JIANG, BEIJING (CN); ZHONG SU, BEIJING (CN); CHANGHUA SUN, BEIJING (CN); GUOYU TANG, BEIJING (CN)

(21) Appl. No.: 14/930,767

(22) Filed: Nov. 3, 2015

(51) Int. Cl. G06Q 30/06; G06Q 30/02

(52) U.S. Cl. CPC G06Q 30/0627; G06Q 30/0282

(57) ABSTRACT

Technical solutions are described for displaying product labels for a product to a user, where the product is associated with a first category. An example method includes analyzing product reviews posted by the user for a set of other products, which includes a second product from a second category, distinct from the first category. The method also includes identifying a set of product labels personalized for the user based on the analysis of the product reviews for other products, including the second product from the second category. The method also includes obtaining a plurality of product labels associated with the product that is being displayed to the user, based on product labels common to the set of product labels for the user and the plurality of product labels of the product. The method also includes displaying the subset of product labels as part of the information of the product.

### BACKGROUND

The present application relates to labeling products, and more specifically, to personalizing labels for a product based on a user's feedback for other products.

Nowadays, more and more people shop online, leading to e-commerce being an increasing growth market worldwide. E-commerce includes both consumer-to-consumer (C2C) and business-to-consumer (B2C) transactions. Attracting shoppers to continuously browse product offerings and purchase from an e-commerce site is a challenge. Product sellers, such as businesses, and e-commerce website operators, facilitate a shopper to identify products that the shopper may like to buy, by providing a product search based on product features. To further attract shoppers, the sellers personalize the shopper's experience, such as by identifying products that other shoppers have bought after buying a product that the shopper is buying, or has bought too.

### SUMMARY

According to an embodiment, a computer implemented method for displaying product labels for a product includes receiving, by a server, an instruction to display information of the product to a user, where the product is associated with a first category. The method also includes analyzing product reviews posted by the user for a set of other products, which includes a second product from a second category, distinct from the first category. The method also includes identifying a set of product labels personalized for the user based on the analysis of the product reviews for other products, including the second product from the second category. The method also includes obtaining a plurality of product labels associated with the product that is being displayed to the user. The method also includes selecting a subset of product labels from the plurality of product labels of the product, the subset being common to the set of product labels for the user and the plurality of product labels of the product. The method also includes displaying the subset of product labels as part of the information of the product.

According to another embodiment, a system for displaying product labels for a product includes a communication interface configured to receive an instruction to display information of the product to a user. The system also includes a memory configured to store a product description of the product. The system further includes a processor that, in response to the instruction to display information of the product to the user, analyzes the product reviews posted by the user for other products, whose categories may be same or distinct from a first category of the product. The processor also identifies a set of product labels personalized for the user based on the analysis of the product reviews for the other products. The processor also extracts, based on the product description, a plurality of product labels associated with the product that is being displayed to the user. The processor also selects a subset of product labels from the plurality of product labels of the product, the subset being common to the set of product labels for the user and the plurality of product labels of the product. The processor also displays the selected subset of product labels as part of the information of the product.

According to yet another embodiment, a computer program product for displaying product labels for a product includes computer readable storage medium. The computer readable storage medium includes computer executable instructions. The computer readable storage medium includes instructions to receive an instruction to display information of the product to a user, and in response to the instruction to display information of the product to the user. The computer readable storage medium also includes instructions to analyze a product review posted by the user for other products, whose categories may be same or distinct from a first category of the product. The computer readable storage medium also includes instructions to identify a set of product labels personalized for the user based on the analysis of the product reviews for the other products. The computer readable storage medium also includes instructions to extract, based on a product description, a plurality of product labels associated with the product that is being displayed to the user. The computer readable storage medium also includes instructions to select a subset of product labels from the plurality of product labels of the product, the subset being common to the set of product labels for the user and the plurality of product labels of the product. The computer readable storage medium also includes instructions to display the selected subset of product labels as part of the information of the product.

### BRIEF DESCRIPTION OF THE DRAWINGS

The examples described throughout the present document may be better understood with reference to the following drawings and description. The components in the figures are not necessarily to scale. Moreover, in the figures, like-referenced numerals designate corresponding parts throughout the different views.

FIG. 1 illustrates an example of product labels being displayed for a product in accordance with an embodiment.

FIG. 2 illustrates example scenario in which different users are interested in different product features of the same product in accordance with an embodiment.

FIG. 3 illustrates an example product label generation system in accordance with an embodiment.

FIG. 4 illustrates a flowchart of extracting product labels for a product in accordance with an embodiment.

FIG. 5 illustrates an example of generating a personalized set of product labels for a particular shopper in accordance with an embodiment.

FIG. 6 illustrates a flowchart for displaying personalized product labels for a shopper requesting to view information of a product in accordance with an embodiment.

FIG. 7 illustrates examples of matching shopper comments about features with product labels and/or dimensions that are personalized for the shopper in accordance with an embodiment.

FIG. 8 illustrates an example in which different product labels are generated and displayed to different shoppers requesting information for the same product in accordance with an embodiment.

FIG. 9 illustrates a flowchart to verify a cross-domain product features association mode in accordance with an embodiment.

### DETAILED DESCRIPTION

Disclosed herein are technical solutions for personalized product labeling based on analysis of product reviews left by shoppers. Typically, all customers see the same product labels for a particular product. The technical solutions facilitate generating different product labels for different customers when viewing the same product in E-commerce. For example, the product labels are generated based on a cross-domain product-to-features association model, which facilitates identifying personalized preferences from product reviews provided by a shopper, and inferring the product labels for a new product based on the personalized preferences. The cross-domain product-to-features association model, maps product features and options using a predefined dimensions like quality, cost-effective, stylish, durable, comfort, environmental protection, and others. The mapping process leverages shopper sentiment analysis, entity and opinion target features, and entity and opinion target semantic categories. The technical solutions, based on these features facilitate vendors, such as E-commerce websites to provide and/or improve personalized service to attract customers.

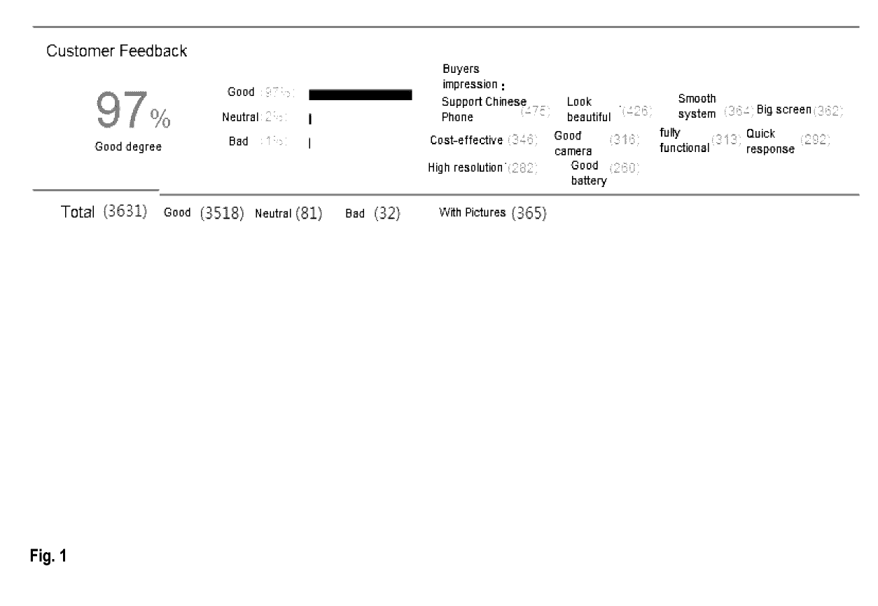

Typically, a shopper provides a review for the product or service on a website, such as AMAZON.COM™, YELP.COM™, and other websites that market, sell, and/or aggregate product reviews. Typically, the websites summarize a review into one or more labels, which are displayed in proximity to the product review for a second shopper to read. Typically, a website displays a label for a product, based on a number of product reviews that contain the label. FIG. 1 illustrates an example of product labels being displayed for a product, with a number of product reviews with those labels. Further, as illustrated, the product labels are typically arranged according to the number of product reviews associated with the product labels. All shoppers see the same product labels for the particular product when browsing the e-commerce website.

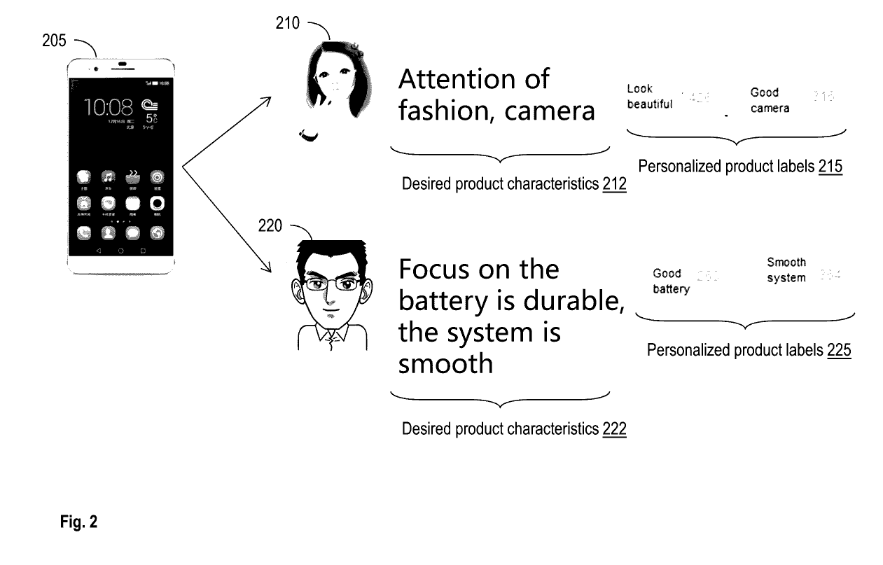

However, different shoppers demand and or focus on different features of a product. FIG. 2 illustrates an example scenario where a first user 210 is interested in the aspects or characteristics 212 represented by product labels 215 of a product 205. Further, a second user 220 is interested in the characteristics 222 represented by product labels 225 of the product 205. The product labels 215 and 225 are personalized for the first and second user respectively based on the desired product characteristics 212 and 222. Further, in another example, a product label displayed may not be useful for a shopper, as the product label may provide redundant information that the shopper already is aware of. For example, a website displaying information about the product 205 may display a product label indicating ‘Supports Chinese Language’. The shopper 210 may glean this information from the brand of the mobile phone itself, and thus, the above product label does not provide useful information to the shopper 210. In addition, in another example, the website displaying the product information does not show one or more product labels that the shopper 210 is interested in. For example, the ‘good battery’ product label is not displayed, which may lead the shopper 210 to browse away from the product 205, which in turn may lead to the website missing a sale of the product 205.

The technical solutions described herein generate personalized product labels for the product 205, for a particular shopper based on analysis of product reviews and feedback that the particular shopper may have left. Further, the technical solutions analyze the product reviews from the particular shopper for products that are in a different category than the product 205. Referring to FIG. 2, the technical solutions generate the product labels 215 for the product 205 for the shopper 210, and the product labels 225 for the same product 205 for the shopper 210. The product labels 215 and the product labels 225 may be distinct from each other. In an example, the web site displaying the product information displays the product labels 215 to the first user 210, while substantially simultaneously displaying the product labels 225 to the second user 220. The technical solutions, in an example, generate the product labels based on the earlier product reviews using sentiment analysis and identifying maximum number of product labels in the product review from a predetermined set of product labels.

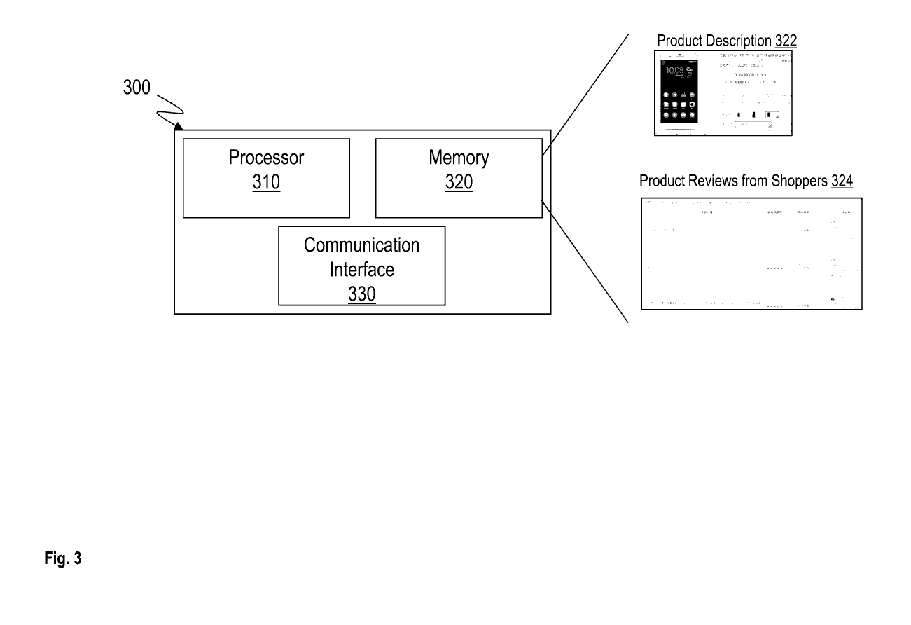

FIG. 3 illustrates an example product label generation system 300. The product label generation 300 includes, among other components, hardware such as a processor 310, a memory 320, and a communication interface 330. The components of the product label generation system 300 may communicate with one or more databases that include product description 322 and product reviews 324. In an example, as illustrated, the database(s) including the product description 322 and the product reviews 324 may be in the memory 320. Alternatively, or in addition, the product description 322 and the product reviews 324 are in separate remote locations, such as remote servers. In addition, the system 300 includes components such as computational devices such as graphics processing unit (GPU), arithmetic unit (AU), or any other co-processor (not shown).

The processor 310 may be a central processor of the product label generation system 300, and is responsible for execution of an operating system, control instructions, and applications installed on the product label generation system 300. The processor 310 may be one or more devices operable to execute logic. The logic may include computer executable instructions or computer code embodied in the memory 320 or in other memory that when executed by the processor 310, cause the processor 310 to perform the features implemented by the logic. The computer code may include instructions executable with the processor 310. The computer code may include embedded logic. The computer code may be written in any computer language now known or later discovered, such as C++, C#, Java, Pascal, Visual Basic, Perl, HyperText Markup Language (HTML), JavaScript, assembly language, shell script, or any combination thereof. The computer code may include source code and/or compiled code. The processor 310 may be a general processor, central processing unit, server, application specific integrated circuit (ASIC), digital signal processor, field programmable gate array (FPGA), digital circuit, analog circuit, or combinations thereof. The processor 310 may be in communication with the memory 320, the communication interface 330, and other components of the product label generation system 300.

The memory 320 is non-transitory computer storage medium. The memory 320 may be DRAM, SRAM, Flash, or any other type of memory or a combination thereof. The memory 320 stores control instructions and applications executable by the processor 310. The memory 320 may contain other data such as images, videos, documents, spreadsheets, audio files, and other data that may be associated with operation of the system 300.

The communication interface 330 facilitates the system 300 to receive and transmit data. For example, the communication interface 330 receives instructions from shoppers 210 and 220, such as in the form of a computer network communication, indicating that the shoppers 210 and 220 have requested to view product information of the product 205. The computer network communication may be wired or wireless and initiated by a client device that the shoppers 210 and 220 use to browse the product information. For example, the client device may be a computer, a smartphone, a tablet, a laptop, a desktop computer, or any other device that facilitates communication with the system 300. Alternatively or in addition, the communication interface 330 facilitates communication in other manners, such as via communication ports like Universal Serial Bus™ (USB), Ethernet, Thunderbolt™, or any other communication ports. The communication interface 330 further facilitates the system 300 to transmit data, such as to display the product labels generated by the system 300. For example, the communication interface 330 facilitates communication with a user interface of the client device that the shoppers 210 and 220 are using. The communication interface 330, in another example accesses information about the product from remote servers. The communication interface 330 further facilitates storing information in the remote computers, such as the information related to the product description 322 and product reviews 324. Of course, the communication interface 330 may communicate to access and store data in other data repositories, other than the product description 322 and product reviews 324.

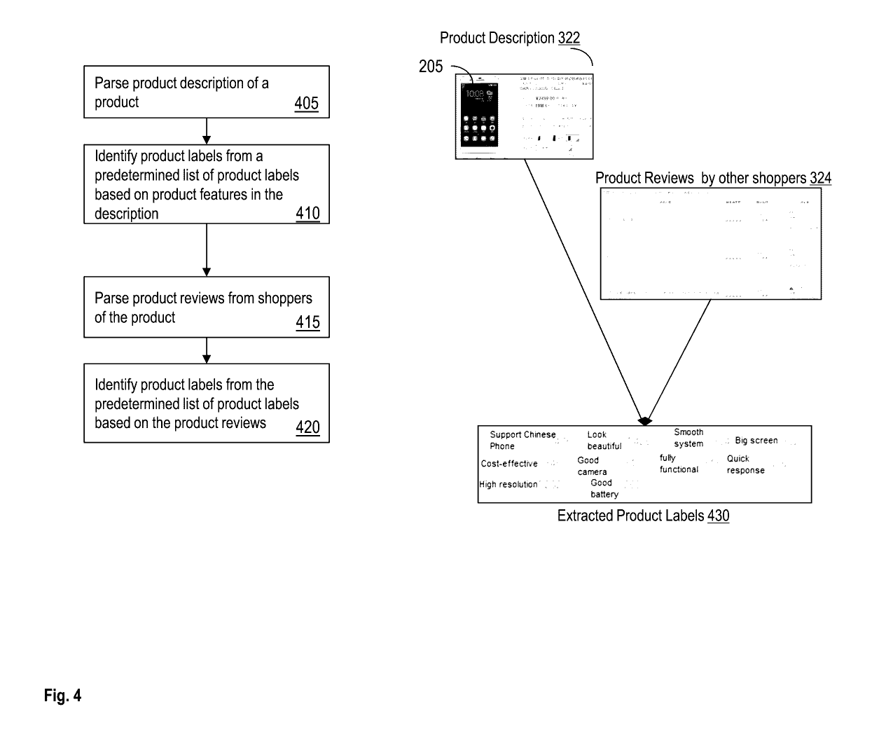

FIG. 4 illustrates a flowchart of extracting product labels for the product 205. The system 300 uses a predetermined list of product labels to extract the product labels for the product 205. The processor 310 parses the product description 322 of the product 205, as shown at block 405. The processor 310 identifies one or more product labels from the predetermined list in the product description 322, as shown at block 410. The processor 310 also parses the product reviews 324 associated with the product 205, as shown at block 415. The processor 310 identifies if the product reviews 324 include one or more of the product labels from the predetermined list, as shown at block 420. The processor 310, in an example, stores a list of extracted product labels 430 for the product 205, the list including a subset of the predetermined list of product labels based on the product labels identified in the product description 322 and the product reviews 324. In an example, the predetermined list may include product labels such as quality, cost-effective, stylish, durable, comfort, environmentally friendly. The predetermined list of product labels is a personalized set of product labels for the shopper that has requested to view information of the product 205.

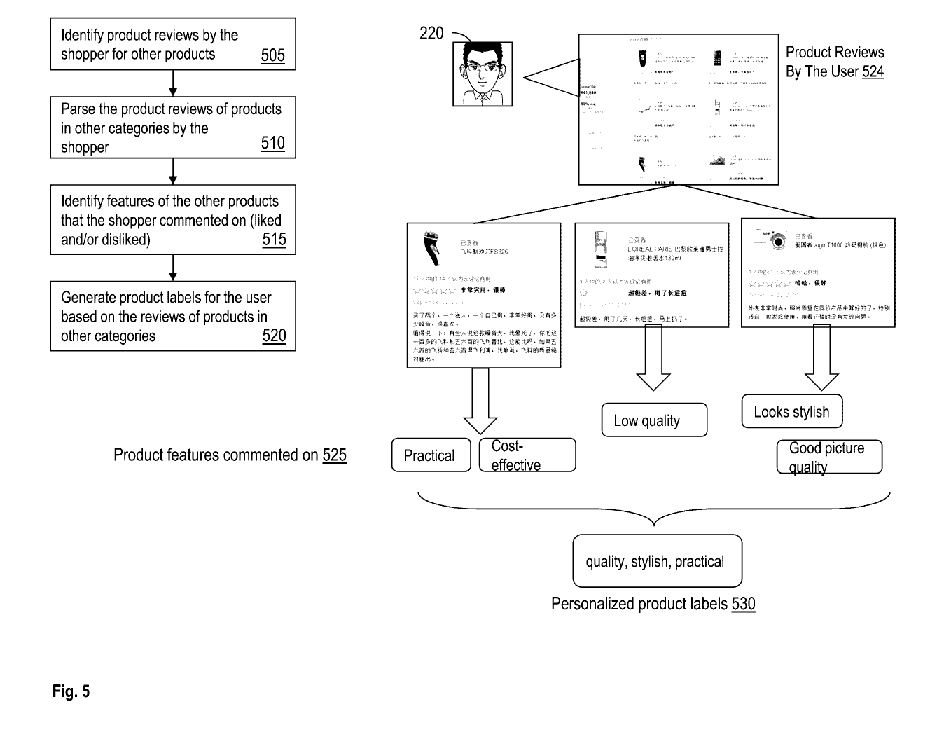

FIG. 5 illustrates an example of generating a personalized set of product labels for a particular shopper, in this case shopper 220. The processor 310 identifies and obtains the product reviews 524 that the shopper 220 has provided for products that are in different categories than the product 205, as shown at block 505. For example, the product 205 is a mobile phone and the product reviews 524 are about a razor, a perfume, and a camera, or any other products that are not in the same category, for example ‘phones’ as the product 205 that the shopper 220 has requested to view. The processor 310 parses the product reviews 524 by the shopper 220 for the products from other categories, as shown at block 510. Based on the parsing, the processor 310 identifies product features 525 of the other products that the shopper 220 commented on, as shown at block 515. For example, the shopper 220 may like and/or dislike particular features of the other products. The processor 310 identifies such product features 525 that the shopper 220 commented on in the product reviews 524. The processor 310 generates a set of personalized product labels 530 for the shopper 220 based on the product features 525. For example, processor 310 keeps count of each of the product features 525 that the shopper 220 has commented on and a count of whether the shopper 220 expressed a positive or a negative sentiment towards each of the product features 525. For example, the shopper 220, in a review of the perfume indicates low quality,' which the processor 310 counts towards a product label such as ‘quality’ and further identifies that the shopper 220 wants good quality products. Further, the processor 310 increments a count of the ‘quality’ feature based on the shopper 220 identifying that a camera the shopper 220 purchased produced ‘good quality pictures.’ Accordingly, the processor 310, based on the product features 525 and the shopper's 220 positive and/or negative annotation for the product features 525 generates the set of personalized product labels 530.

In another example, the processor 310 refers to a predetermined set of product labels. The predetermined set of product labels includes predefined product labels that are applicable to products regardless of the products' category, use, source and is a collection of characteristics of products that the processor 310 can choose from. For example, the processor 310 generates the set of personalized product labels 530 based on the predetermined set of product labels. For example, the processor 310 semantically analyzes the product reviews 525 to identify one or more of the product labels from the predetermined set of product labels being indicated in the product reviews 525. In an example, the processor 310 identifies a phrase in the product reviews 525 as being indicative of a product label from the predetermined set of product labels in response to the phrase being identical to the product label. Alternatively or in addition, the processor 310 identifies the phrase as being indicative of the product label in response to the phrase including synonymous words as the product label. In an example, the processor 310 extracts product labels 430 for the product 205 based on the product description 322 and/or product reviews 324 based on the same predetermined set of product labels.

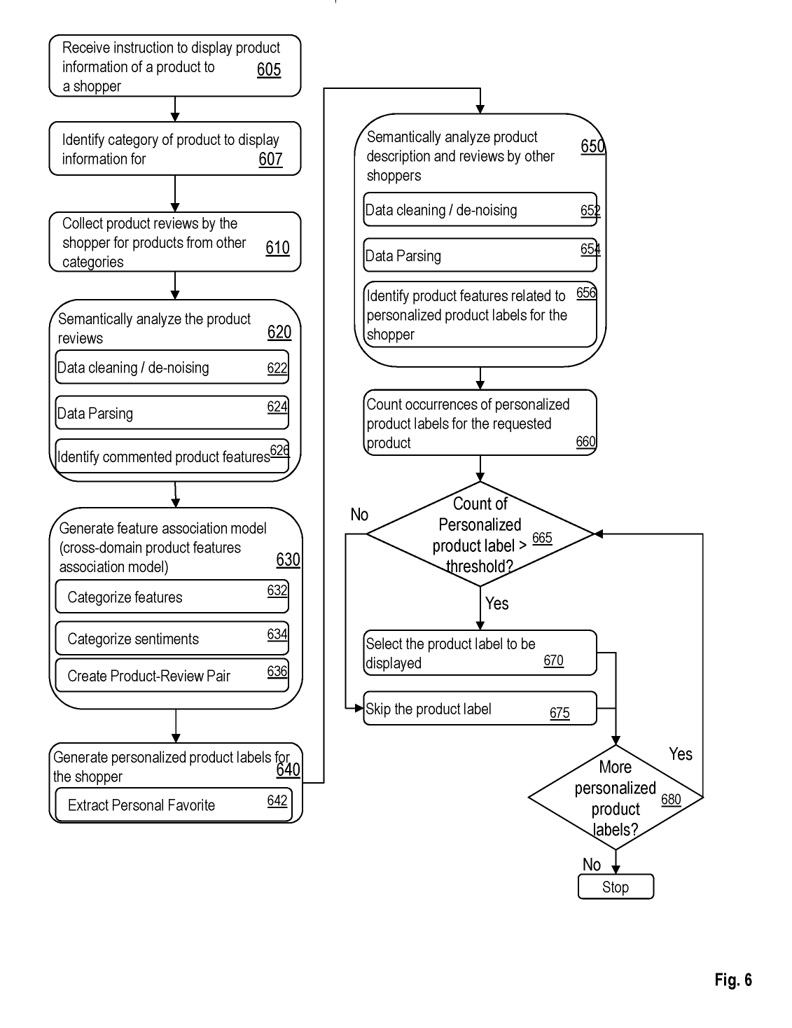

FIG. 6 illustrates a flowchart for displaying personalized product labels for a shopper requesting to view information of a product. The communication interface 330 receives an instruction from a client device of a shopper to view product information of a product, such as the product 205, as shown at block 605. The processor 310 identifies a category of the product 205, as shown at block 607. For example, the processor 310 uses a predetermined list of product categories to identify a product category for the product 205. Alternatively, the processor 310 uses a product category that is listed in the product description of the product 205. The processor 310 collects product reviews 525 that the shopper has provided for products from other categories, as shown at block 610. For example, the processor 310 identifies a set of product reviews that the shopper has provided from the product reviews 324, and further, from that set of product reviews, identifies the product reviews that are for products that do not belong to the same category as the product 205.

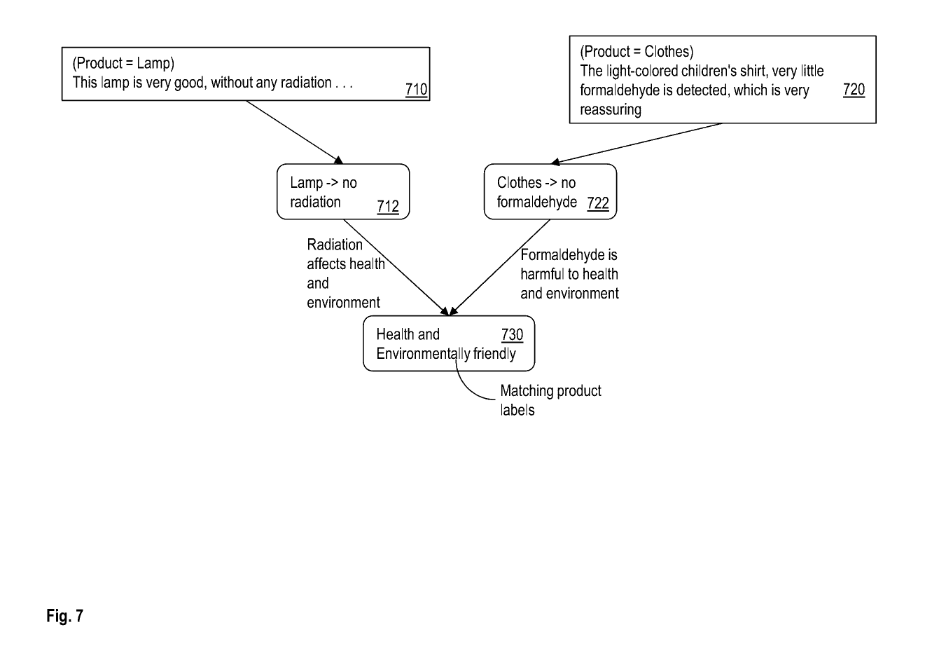

The processor 310 semantically analyzes the product reviews from the shopper, as shown at block 620. The semantic analysis may include data de-noising or cleaning prior to parsing the data in the product reviews, as shown at blocks 622 and 624. The processor 310 parses the product reviews to identify the features that the shopper has commented on in the product reviews, as shown at block 626. The processor 310 further generates a feature association model, as shown at block 630. The feature association model is a cross-domain product features association model that matches the features that the shopper has commented about with product labels. FIG. 7 illustrates examples of matching shopper comments about features with product labels and/or dimensions that are personalized for the shopper. For example, a product review 710 is about a lamp, in which the shopper has expressed praise about the lamp based on “lamp is very good, without any radiation.” In another product review 720, which is about clothes, the shopper has expressed reassurance based on “the light-colored children's shirt . . . with very little formaldehyde detected.” The processor 310 extracts the features and corresponding sentiment about the feature from the product reviews and categorizes the features, as shown at block 632. For example, as shown in FIG. 7, the processor 310 categorizes the features related to radiation and the formaldehyde for the lamp and the clothes respectively to a ‘health’ category. The processor 310 categorizes the features based on domain knowledge, product specification, and background knowledge, that the processor 310 obtains from the memory 320. Further, the processor 310 categorizes the sentiment expressed by the shopper regarding the extracted and categorized features in the product reviews, as shown at block 634. For example, in FIG. 7, the shopper expressed a positive sentiment based on the praise and reassurance about the radiation and formaldehyde features respectively, as shown at blocks 712 and 722. Accordingly, the processor 310 infers that the extracted and categorized features are desirable features for the shopper and further generates a product-review tuple that indicates a product category, a product feature, a feature sentiment, and a sentiment polarity. For example, in the examples of FIG. 7, the processor generates product-review tuples for the lamp and the clothes as follows.

Lamp Tuple=(lamp, no radiation, praise, positive).
Clothes Tuple=(clothes, no formaldehyde, reassurance, positive).

Based on the tuples, the processor 310 generates a set of personalized product labels for the shopper, as shown at block 640. For example, the processor 310 extracts the product features that are the shopper's favorite, as shown at block 642. For example, the processor extracts the favorite product features based on a count of the product features being commented about in the product reviews. For example, in the FIG. 7, the features commented about in the product reviews 710 and 720 are both categorized into health and/or environmentally friendly categories, as shown at blocks 712 and 722. Accordingly, the processor 310, in this case, identifies ‘health’ and ‘environmentally friendly’ as product characteristics that the shopper desires, and hence, as the personalized product labels for the shopper, as shown at block 730.

The processor 310 semantically analyzes product description and reviews 324 by other shoppers, as shown at block 650. As described herein with respect to block 620, the semantic analysis of the product description and product reviews by the other shoppers includes cleansing/de-noising, parsing, and identifying product features, as shown at blocks 652, 654, and 656. In an example, the processor 310 identifies the product features that correspond to the product labels personalized for the shopper earlier in the process. In an example, the processor 310 keeps track of counts of the personalized product labels identified in the product description and the reviews by other shoppers, as shown at block 660. Depending on a count of a product label, the processor 310 selects the product label for display as part of the product information. For example, the processor 310 compares the count of a product label with a predetermined threshold, as shown at block 665. If the count of the product label is above the predetermined threshold, the processor 310 selects the product label for display, as shown at block 670. Else, the processor 310 skips the product label, and does not display the product label as part of the product information, as shown at block 675. The processor 310 checks each product label that was identified, as shown at block 680.

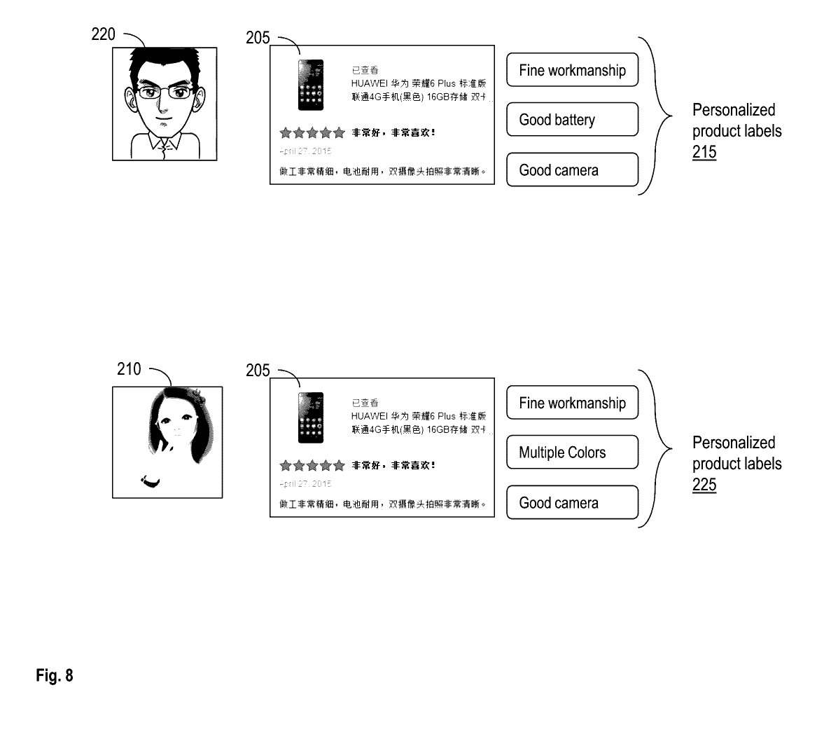

FIG. 8 illustrates an example in which the processor 310 generates and displays different product labels 215 and 225 to different shoppers 210 and 220 who requested information for the same product 205. The product labels 215 and 225 are identified and personalized for the respective shoppers 210 and 220, according to the example process described herein. As shown, the set of product labels 215 is distinct from the set of product labels 225.

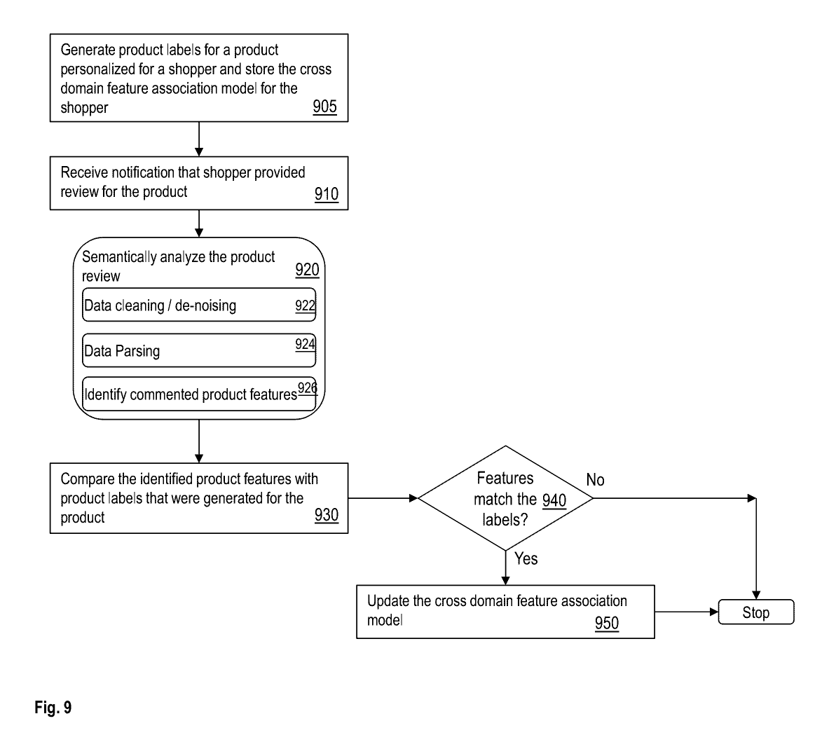

FIG. 9 illustrates a flowchart to verify a cross-domain product features association model that the processor 310 generates for a shopper. As described herein, the cross-domain product features association model matches the features that the shopper has commented about with product labels. The processor 310 generates product labels for the product 205 that are personalized for the shopper 210. The processor 310 generates the product labels based on a cross-domain feature association model using product reviews from the shopper 210 for products from other categories, as described herein. The processor 310, in an example, stores the cross domain feature association model, as shown at block 905. In an example, the processor 310 receives a notification when the shopper 210 provides a product review for the product 205, as shown at block 910. The shopper 210 may provide the product review via the same website that the shopper 210 requested the product information for the product 205. Alternatively, the shopper 210 provides the product review via another website. For example, the shopper browses the product information via AMAZON.COM™, and thus, the processor 310 generates and displays the product labels for the product 205 via AMAZON.COM™. Later, the shopper 210 provides a product review via YELP.COM™, a different website. Of course, in an example, the shopper 210 provides the product review via the same website, in this case, AMAZON.COM™.

The processor 310 semantically analyzes the product review from the shopper 210 for the product 205, as shown at block 920. The analysis, as described elsewhere herein, includes data cleansing/de-noising, parsing, and identifying product features that the shopper 210 commented about in the product review, as shown at block 922, 924, and 926. The processor 310 compares the product features that the shopper commented about and the personalized product labels that the processor 310 had generated, as shown at block 930. If the identified product features do not match the product labels that were generated, the processor 310 updates the cross domain association model that was stored, to update the shopper 210's preferences, as well as the association of the features and the product labels in the model, as shown at blocks 940 and 950. The cross domain feature association model is, thus, improved for future product label generation.

Thus, the technical solutions described herein generate a cross-domain product features association model that associates features of products from different categories based on a shopper's preferences. The product features and corresponding options are mapped using predefined high-level dimensions/product labels that the shopper prefers, such as quality, cost-effective, stylish, durable, comfort, environmentally friendly. The product features of products from across the categories, which match with the predefined product labels are then associated with each other in the cross-domain association model. The mapping process also leverages sentiment features, entity and opinion target features, and entity and opinion target semantic categories. The technical solution facilitate mapping a shopper's ‘personality’, that is preferences, into the predefined product labels based on product reviews from the shopper. The most matched labels of a new product are identified and displayed for the shopper based on labels of the product and the product labels identified for the shopper.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or technical improvement over technologies found in the marketplace, or to enable others of ordinary skill in the art to understand the embodiments disclosed herein.

1-9. (canceled)

10. A system for displaying product labels for a product, the system comprising:
a communication interface configured to receive an instruction to display information of the product to a user;
a memory configured to store a product description of the product; and
a processor configured to, in response to the instruction to display information of the product to the user:
analyze product reviews posted by the user for a set of other products, which comprises a second product from a second category distinct from a first category of the product;
identify a set of product labels personalized for the user based on the analysis of the product reviews for the other products;
extract, based on the product description, a plurality of product labels associated with the product that is being displayed to the user;
select a subset of product labels from the plurality of product labels of the product, the subset being common to the set of product labels for the user and the plurality of product labels of the product; and
display the selected subset of product labels as part of the information of the product.

11. The system of claim 10, wherein a product label represents a characteristic of the product.

12. The system of claim 10, wherein the processor is further configured to, display, in conjunction with a product label from the selected subset of product labels, a count representative of a number of reviews from other users that matched the product label.

13. The system of claim 10, wherein for the identification of the set of product labels personalized for the user based on the analysis of the product review for the other products, the processor is further configured to:
select a product label from a predetermined set of product labels;
semantically analyze the product reviews of the other products to identify a count of phrases that are representative of the product label from the predetermined set of product labels; and
select the product label as part of the set of product labels personalized for the user based on the count being greater than a predetermined threshold.

14. The system of claim 13, wherein for the extraction of the plurality of product labels associated with the product that is being displayed to the user, the processor is further configured to:
parse the product description of the product to identify features of the product; and
associate the features of the product with the predetermined set of product labels.

15. The system of claim 13, wherein the predetermined set of product labels comprises one or more of quality, cost-effective, stylish, durable, comfort, and environmentally safe.

16. The system of claim 10, wherein the user is a first user, the set of other products is a first set of other products, the subset of product labels is a first subset of product labels, and wherein:
the communication interface is configured to receive another instruction to display information of the product to a second user; and
the processor is further configured to, in response to the another instruction corresponding to the second user:
identify a set of product labels personalized for the second user based on an analysis of a second set of product reviews by the second user for a second set of other products, which comprises at least one product from a category distinct from the first category;
select a second subset of product labels from the plurality of product labels of the product that includes product labels common to the set of product labels personalized for the second user and the plurality of product labels of the product, wherein the second subset for the second user is distinct from the first subset for the first user; and
display the second subset of product labels as part of the information of the product to the second user.

17. A computer program product for displaying product labels for a product, the computer product comprising computer readable storage medium, the computer readable storage medium comprising computer executable instructions, wherein the computer readable storage medium comprises instructions to:
receive an instruction to display information of the product to a user; and
in response to the instruction to display information of the product to the user:
analyze a product review posted by the user for a set of other products, which includes a second that is from a second category, distinct from a first category of the product;
identify a set of product labels personalized for the user based on the analysis of the product reviews for the other products;
extract, based on a product description, a plurality of product labels associated with the product that is being displayed to the user;
select a subset of product labels from the plurality of product labels of the product, the subset being common to the set of product labels for the user and the plurality of product labels of the product; and
display the selected subset of product labels as part of the information of the product.

18. The computer program product of claim 17, wherein the computer readable storage medium further comprises instructions to, display, in conjunction with a product label from the selected subset of product labels, a count representative of a number of reviews from other users that matched the product label.

19. The computer program product claim 17, wherein for the identification of the set of product labels personalized for the user based on the analysis of the product review for the other products, the computer readable storage medium further comprises instructions to:
select a product label from a predetermined set of product labels;
semantically analyze the product review of the other product to identify a count of phrases that are representative of the product label from the predetermined set of product labels; and
select the product label as part of the set of product labels personalized for the user based on the count being greater than a predetermined threshold; and
wherein, for the extraction of the plurality of product labels associated with the product that is being displayed to the user, the computer readable storage medium further comprises instructions to:
parse the product description of the product to identify features of the product; and
associate the features of the product with the predetermined set of product labels.

20. The computer program product of claim 19, wherein the predetermined set of product labels comprises one or more of quality, cost-effective, stylish, durable, comfort, and environmentally safe.
